(19) United States
(12) Patent Application Publication
(10) Pub. No.: US 2025/0158344 A1
(43) Pub. Date: May 15, 2025

(54) LASER BEAM DUMP ASSEMBLY AND METHOD OF MANUFACTURE

(71) Applicant: NEWPORT CORPORATION, Irvine, CA (US)

(72) Inventor: Wen JIN, Irvine, CA (US)

(73) Assignee: NEWPORT CORPORATION, Irvine, CA (US)

(21) Appl. No.: 18/508,656

(22) Filed: Nov. 14, 2023

(51) Int. Cl. H01S 3/10; H01S 3/04

(52) U.S. Cl. CPC H01S 3/10023; H01S 3/0405

(57) ABSTRACT

The present application discloses embodiments of a laser beam dump assembly. In one embodiment, the laser beam dump assembly includes a beam dump housing having a housing body with a passage formed therein, wherein the passage is sized to allow an incident laser beam to propagate therethrough into an interior volume formed in the housing body. The laser beam dump assembly further includes a beam scattering member having curvilinear scattering surface configured to scatter or reflect a first portion of the incident laser beam and allow a second portion of the incident laser beam to be absorbed by the scattering member as thermal energy. A heat sink is coupled to the beam dump housing in thermal communication with the beam scattering member, wherein the heat sink is configured to absorb and dissipate the thermal energy from the beam scattering member.

### BACKGROUND

Laser beam dumps are used for a variety of applications to absorb laser radiation that is not wanted or is not necessary for a particular experiment or application (e.g., beams with undesired polarization or wavelength). Laser beam dumps use a variety of features to direct, scatter, and absorb laser radiation. Such features include absorptive metals and coatings (e.g., black-anodized aluminum, black-tar coated materials, neutral-density glass, or compressed graphite). Many laser beam dumps include heat sinking devices or features to absorb, conduct, radiate, or convect heat from absorbed laser energy into the ambient environment.

While these prior art laser beam dumps have proven useful in the past, a number of shortcomings have been identified. For example, prior art beam dumps often use relatively small absorbing surfaces or scattering surfaces that can be damaged by laser beams that have high laser fluence or high peak power. Such beam dumps may require forced convection (e.g., cooling fans, water cooling) that may cause unwanted vibration, or may be expensive to implement. Also, many prior art beam dumps are limited to maximum operating temperatures of about 500° C. and below. As such, the upper limit of laser power directed to these beam dumps may be relatively low. In light of the foregoing, there is an ongoing need for an improved laser beam dump that can handle high laser powers in a compact form factor and an inexpensive or package.

### SUMMARY

The present application discloses embodiments of a laser beam dump assembly. In one embodiment, the laser beam dump assembly includes at least one beam dump housing having at least one housing body having at least one passage formed therein, wherein the passage is sized to allow at least one incident laser beam to propagate therethrough into at least one interior volume formed in the housing body. The beam dump assembly further includes at least one heat sink detachably coupled to the beam dump housing and in thermal communication with at least one beam scattering member. The beam scattering member includes at least one curvilinear scattering surface configured to scatter or reflect at least a first portion of the incident laser beam and allow a second portion of the incident laser beam to be absorbed by the scattering member as thermal energy, and the heat sink is configured to absorb at least a portion of the thermal energy from the beam scattering member.

In another embodiment, the laser beam dump assembly includes at least one beam dump housing having at least one housing body having at least one passage formed therein, wherein the passage is sized to allow at least one incident laser beam to propagate therethrough. At least one beam scattering member having at least one curvilinear scattering surface configured to scatter or reflect at least a first portion of an incident laser beam and allow a second portion of the incident laser beam to be absorbed by the beam scattering member as thermal energy is placed in optical communication with the incident laser beam. The laser beam dump assembly further includes at least one heat sink in thermal communication with the beam scattering member.

In another embodiment, the laser beam dump assembly includes at least one beam dump housing having at least one passage formed therein, wherein the passage is sized to allow at least one incident laser beam to propagate therethrough. The beam dump assembly further includes at least one beam scattering member having at least one curvilinear scattering surface configured to scatter or reflect at least a first portion of the incident laser beam, wherein the beam scattering member is in thermal communication with at least one heat sink.

The curvilinear beam scattering surface may have any of a number of shapes, including spherical, hemispherical, aspherical, elliptical, oval, cylindrical, or parabolic shapes.

The beam scattering member may be formed from any of a variety of materials selected from a group consisting of ceramic, silicon carbide, silicon nitride, coper tungsten, tungsten carbide, aluminum nitride, boron carbide, a silicon carbide/boron carbide ceramic composite, zirconia, zirconia-toughened alumina, alumina-toughened zirconia, and machinable glass ceramic materials.

### BRIEF DESCRIPTION OF THE DRAWINGS

Various embodiments of an improved laser beam dump will be explained in more detail by way of the accompanying drawings, wherein:

FIGS. 1 and 2 show cross-section views of embodiments of prior art laser beam dumps.

FIG. 3 shows a cross-section view of an embodiment of an improved laser beam dump.

FIG. 4 shows an exploded section view of the heat sink and the scattering member of the laser beam dump assembly shown in FIG. 3.

### DETAILED DESCRIPTION

Example embodiments are described herein with reference to the accompanying drawings. Unless otherwise expressly stated, in the drawings the sizes, positions, etc., of components, features, elements, etc., as well as any distances therebetween, are not necessarily to scale, and may be exaggerated for clarity. In the drawings, like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

The terminology used herein is for the purpose of describing particular exemplary embodiments only and is not intended to be limiting. Unless otherwise defined, all terms (including technical and scientific terms) used herein have the same meaning as commonly understood by one of ordinary skill in the art. As used herein, the singular forms “a,” “an” and “the” are intended to include the plural forms as well, unless the context clearly indicates otherwise. Also, the terms “at least one” “at least a”, and “one or more” may are intended to include both the singular and plural forms, depending on the context. It should be recognized that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless indicated otherwise, terms such as “first,” “second,” etc., are only used to distinguish one element from another. For example, one coupler could be termed a “first coupler” and similarly, another coupler could be termed a “second coupler”, or vice versa.

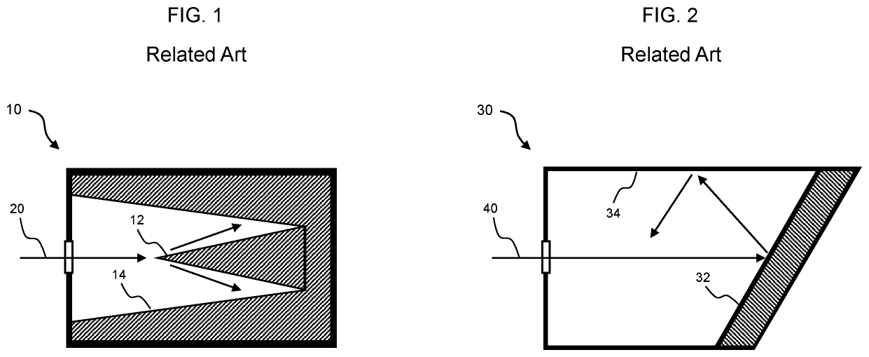

Unless indicated otherwise, spatially relative terms, such as “below,” “beneath,” “lower,” “above,” and “upper,” “opposing,” and the like, may be used herein for ease of description to describe one element or feature's relationship to another element or feature, as illustrated in the FIG. 1t should be recognized that the spatially relative terms are intended to encompass different orientations in addition to the orientation depicted in the FIGS. For example, if an object in the FIGS. is turned over, elements described as “below” or “beneath” other elements or features would then be oriented “above” the other elements or features. Thus, the exemplary term “below” can encompass both an orientation of above and below. An object may be otherwise oriented (e.g., rotated 90 degrees or at other orientations) and the spatially relative descriptors used herein may be interpreted accordingly. A set of reference axes (e.g., X, Y, Z), directions, or coordinates, and the rotation around them (e.g., Ox, OY, OZ) may be included in the FIGS. for the purpose of orienting the reader to facilitate understanding of the FIGS. and the specification, and do not necessarily indicate that any particular feature or element is aligned with, or is orthogonal to, any other feature or element.

The paragraph numbers used herein are for organizational purposes only, and, unless explicitly stated otherwise, are not to be construed as limiting the subject matter described. It will be appreciated that many different forms, embodiments and combinations are possible without deviating from the spirit and teachings of this disclosure and so this disclosure should not be construed as limited to the example embodiments set forth herein. Rather, these examples and embodiments are provided so that this disclosure will be thorough and complete, and will convey the scope of the disclosure to those skilled in the art.

FIGS. 1 and 2 show schematic cross-sectional view of prior art beam dump arrangements. The beam dump 10 shown in FIG. 1 uses a conical scattering surface 12 that scatters an incident beam 20 onto a inverse conical scattering surface 14. At least one shortcoming of this arrangement is that the conical surface 12 presents a very small reflecting/scattering area and is therefore more prone to damage and degradation. The beam dump 30 shown in FIG. 2 uses a scattering surface 32 arranged at an angle relative to an incident laser beam 40, so that the incident beam 40 is scattered to a second scattering surface 34. At least one shortcoming of this arrangement is that the scattering surface 32 scatters the incident beam 40 in only one direction, resulting in most of the incident power being concentrated in a single point on the first scattering surface 32 and the second scattering surface 34. This can result in poor heat dissipation because the absorption area is relatively small.

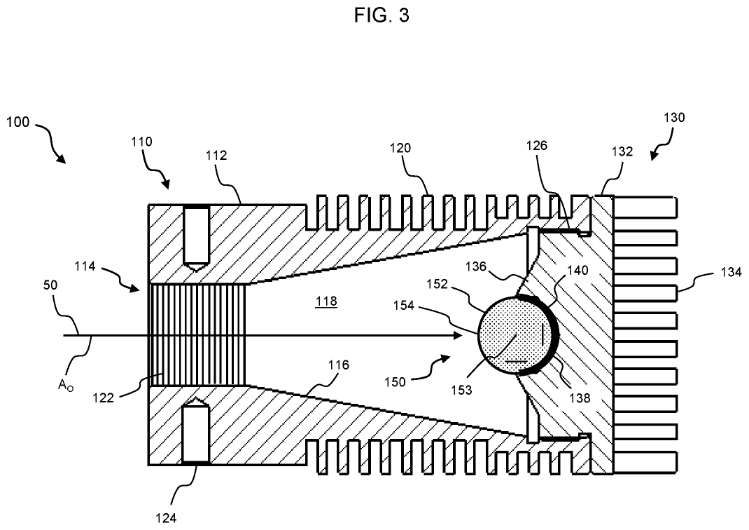

FIG. 3 shows a cross-section view of an example embodiment of a beam dump assembly 100 configured to absorb at least a portion of at least one incident laser beam 50 (also referred to herein as the “laser beam 50”, or “the beam 50”) propagating along an optical axis Ao. The beam dump assembly 100 includes at least one beam dump housing 110 (also referred to herein as the “housing 110”), at least one heat sink 130, and at least one beam scattering member 150 (also referred to herein as the “scattering member 150”). The scattering member 150 is configured to scatter at least a portion of the incident laser beam 50. The housing 110 has at least one housing body 112 with at least one interior scattering surface 116 (also referred to herein as “the interior surface 116”) defining at least one interior volume 118. In one embodiment, the interior surface 116 is configured to scatter or reflect at least a portion of the laser beam 50 and/or to absorb at least a portion of the laser beam 50 that is scattered by the scattering member 150, thereby dissipating at least a portion of the energy of the laser beam 50. In another embodiment, the interior surface 116 is configured to scatter or reflect the majority of the portion of the laser beam 50 that is scattered by the scattering member 150. At least one passage 114 is formed in the housing body 112, wherein the passage 114 is configured to allow at least one incident laser beam 50 to pass therethrough into the interior volume 118. In the illustrated embodiment, the housing body 112 also includes one or more thermally conductive features 120 formed thereon and one or more fastener passages 124 formed therein.

In the illustrated embodiment, one or more features 122 are formed the housing body 112 along the passage 114. In this embodiment, the features 122 are internal threads configured to mechanically couple the beam dump assembly 100 to an external device, such as a lens tube (not shown). In another embodiment, the features 122 are surface relief features configured to prevent at least a portion of the incident laser beam 50 that is reflected from the scattering member 150 to exit the interior volume 118. These surface relief features 122 may have any of a variety of shapes, include, without limitation, square tooth shapes, sawtooth shapes or the like or any combination thereof. One or more fastener passages 124 may be formed in the housing body 112, wherein the fastener passages 124 are configured to mechanically couple the beam dump 100 assembly to an external device, such as one or more components of an optical rail system, an optical post, or an optical post system. In other embodiments, the coupling features 122 or fastener passages 126 (described below) may be used to install the beam dump assembly 100 into a laser, laser system, or other photonic instrument or system.

In the illustrated embodiment, one or more coupling features 126 (e.g., female threads) may be formed in the housing body 112, wherein the one or more coupling features 126 are configured to engage one or more corresponding coupling features (e.g., male threads) formed on the heat sink body 132. When provided as such, the heat sink 130 may be detachably coupled to the housing body 112, thereby enabling the replacement of any of the housing 110, the heat sink 130, and/or the beam scattering member 150. In other embodiments, the heat sink 130 may be formed integral to or monolithically with the housing body 112.

The housing body 112 and the heat sink body 132 may be formed from a wide variety of materials selected based on their thermal properties, including, without limitation, heat conductivity, heat capacity, coefficient of thermal expansion, melting point, laser-induced damage threshold (LIDT), or the like or any combination thereof. Such materials include, without limitation, aluminum, copper, steel, stainless steel, or any of a wide variety of alloys of these metals. In some embodiments, the housing 110 or the heat sink body 132 may include a temperature indicator (e.g., a feature that glows red or another color) that indicates when a particular temperature range is exceeded. In other embodiments, temperature-measuring devices (e.g., thermocouples, thermistors, or optical temperature probes) may be connected to the housing body 112 and/or the heat sink body 132 so that an operator or user of the beam dump assembly 100 may avoid injury when operating the beam dump assembly 100. In some embodiments, such temperature-measuring devices may be used to calculate the optical power of the incident laser beam 50.

In the illustrated embodiment, the thermally conductive features 120 are provided as cooling fins arranged to allow thermal energy present in the housing body 112 to radiate or be convected into the ambient environment surrounding the beam dump assembly 100. The thermal energy may be transmitted into the ambient environment from the thermally conductive features 120 via free convection or radiation. In other embodiments, thermal energy present in the housing body 112 may be removed using forced convection, such as a fan that blows air over the thermally conductive features 120. Those skilled in the art will appreciate that thermal energy present in the housing body 112 may be removed by any variety or combination of heat transfer mechanisms.

In the illustrated embodiment, the heat sink 130 includes at least one heat sink body 132 having a protrusion 136 formed thereon, with at least one recess 138 formed in the protrusion 136. In the illustrated embodiment, the heat sink body 132 includes one or more thermally conductive features 134 formed thereon. The thermally conductive features 134 are configured to conduct thermal energy present in the heat sink body 132 away from the thermally conductive features 134 in any of the variety of ways described above with respect to the thermally conductive features 120. In the illustrated embodiment, the recess 138 is sized to receive the scattering member 150 so that the scattering member 150 is in thermal communication with the heat sink body 132. In various embodiments, the recess 138 may have a variety of shapes configured to effectively transfer thermal energy from the scattering member 150 to the heat sink body 132. For example, in one embodiment, the recess 138 may have a concave spherical surface having the same radius as the scattering member 150, in order to enhance the transfer of thermal energy from the scattering member 150 to the heat sink 130. In some embodiments, a fastening feature 140 is disposed in the recess 138. In one embodiment, the fastening feature 140 is a bonding compound, bonding agent, or adhesive, such as a thermally conductive epoxy selected to retain the scattering member 150 and effectively transfer thermal energy from the scattering member 150 to the heat sink body 132. The fastening feature 140 may be mechanical (e.g., set screw, clamping member, press fit, crimping or staking of the scattering member 150 within the recess 138).

In the illustrated embodiment, the scattering member 150 includes a curvilinear scattering surface 152 (also referred to herein as the “scattering surface 152” or the “surface 152”) having a center 153 (e.g., when the scattering surface 152 has a center, such as when the scattering surface 152 is spherical, hemispherical, cylindrical, etc.). In the illustrated embodiment, the center 153 of the scattering surface 152 is aligned with the optical axis Ao of the laser beam 50. In other embodiments, the center 153 of the scattering surface 152 may be offset from the optical axis of the laser beam 50. In other embodiments, the scattering surface 152 may not have a center. In other embodiments, the scattering surface 152 has one or more centering features, points, or lines of symmetry when the scattering surface 152 has some degree of symmetry. For example, when the scattering surface 152 has an elliptical or parabolic shape, the centering feature might be a focus of the parabola or one of the foci of an ellipse. In other embodiments, the scattering surface 152 may not have a centering feature, point, or line of symmetry. In one embodiment, the scattering surface 152 is configured to scatter or reflect at least a portion of and allow a second portion of the incident laser beam 50 to be absorbed by the scattering member 150, thereby dissipating at least a portion of the energy of the incident laser beam 50. As such, the scattering surface 152 is configured to absorb at least a portion of the incident laser beam 50 as thermal energy. In another embodiment, the scattering surface 152 is configured to scatter or reflect all of the incident laser beam 50.

In the illustrated embodiment, the scattering surface 152 has an incident point 154 where the incident laser beam 50 is incident on the scattering surface 152. In other embodiments, the scattering surface 152 has multiple scattering surfaces. In the illustrated embodiment, the scattering surface 152 is a convex spherical shape. In other embodiments, the scattering surface 152 may have other convex shapes (hemispherical, aspherical, elliptical, parabolic, oval, cylindrical, or semi-cylindrical). In still other embodiments, the scattering surface 152 may have a concave shape (hemispherical, aspherical, elliptical, parabolic, oval, cylindrical, or semi-cylindrical). In yet other embodiments, the scattering surface 152 may have a random convex or concave shape. In still other embodiments, the scattering surface 152 may not have a curvilinear shape. For example, the scattering surface 152 may have convex or a concave angular shape (e.g., triangular, pentagonal, hexagonal, etc.) Those skilled in the art will appreciate that the scattering surface 152 may have any shape.

In the illustrated embodiment, the scattering member 150 is formed from a refractory material that is capable of handling an incident laser beam 50 that has a very high peak power or average power, usually measured in Watts (also expressed as laser energy per pulse in Joules, divided by pulse width in seconds, when applied to pulsed lasers) without damage (e.g., spalling, pitting, ablation, breakdown, sublimation, or melting), or at least with minimal damage. As such, the scattering member 150 may be formed from a wide variety of materials selected based on their thermal properties, including, without limitation, heat conductivity, heat capacity, coefficient of thermal expansion, melting point, laser-induced damage threshold (LIDT), or the like or any combination thereof. In addition, the material of the scattering member 150 may be selected to have sufficiently high thermal shock properties to avoid damage due to rapid heating by absorption of the laser beam 50. The material of the scattering member 150 may also be also selected to handle very high laser fluence (also known as power density or energy density, as measured in Joules per square centimeter (J/cm²). Also, the material of the scattering member 150 may be selected based on its ability to withstand very high temperatures (e.g., above 500° C., above 1000° C., or above 1,500° C.). The material of the scattering member 150 may be selected based on its volumetric coefficient of thermal expansion (i.e., a change in volume that take place in response to temperature change, usually measured in ° C.⁻¹), so that the scattering member 150 does not break free of the fastening feature 140. For example, in various embodiments, the scattering member 150 may be capable of operating at laser powers from 30 to 80 watts and laser fluence of 40 to 150 J/cm², though those skilled in the art will appreciate that the scattering member 150 may be capable of operating at laser power above 80 watts and laser fluence above 150 J/cm².

Even though the material of the scattering member 150 is selected to have the properties described above, some damage is expected to occur, and in embodiments where the heat sink 130 is detachably coupled to the housing 110, the scattering member 150 (and the heat sink 130) may be readily replaced. In other embodiments, the beam dump assembly 100 may be configured for particular applications, such as various powers of the laser beam 50. One of the materials listed below may be used for mid-power applications, while another of the materials listed below may be chosen for high-power applications. In addition, the material of the scattering member 150 may be selected based on the expected wavelength of the laser beam 50, or the expected pulse characteristics (e.g., CW, pulsed, or quasi-CW), for example, and due to the scattering member's expected absorption or scattering of the laser beam relative to wavelength. In one embodiment, the scattering member 150 is formed from Silicon Carbide having a polished scattering surface 152. In another embodiment, the scattering member 150 is formed from Silicon Carbide having a scattering surface 152 with a desired roughness or anti-reflective features. In another embodiment, the scattering member 150 is formed from Silicon Nitride having a polished scattering surface 152. In other embodiments, the scattering member 150 may be formed from any of a wide variety of materials, including, without limitation, Aluminum Nitride (AlN) Boron Carbide (B₄C), a Silicon Carbide/Boron Carbide ceramic composite (SiC/B₄C), Zirconia (ZrO₂), Zirconia-toughened Alumina (Zr—Al₂O₃), Alumina-toughened Zirconia (Al₂O₃—Zr), or MACOR® machinable glass ceramic, or the like or any combination thereof. Those skilled in the art will appreciate that the scattering member 150 may be formed from any of a wide variety of materials or combinations of materials.

While in some embodiments, the scattering surface 152 may be polished, in other embodiments, one or more coatings may be applied to the scattering surface 152, for example, to extend its operating lifetime or to handle extremely high laser fluence. Such coatings include, but are not limited to single layer or multilayer dielectric coatings including, without limitation, Calcium Fluoride (CaF₂), Silicon Dioxide (SiO₂), and Magnesium Fluoride (MgF₂). In other embodiments, coatings such as Diamond Like Carbon (DLC), Titanium Nitride (TIN), Chromium Nitride (CrN), Chromium Carbo-Nitride, Titanium Carbo-Nitride (TiCN), Titanium Aluminum Nitride (AltiN), or the like or any combination thereof. These coatings may be selected to enhance or control the scattering, reflectivity, or absorption of the incident laser beam 50 by the scattering member 150. In other embodiments, the scattering surface 152 may include one or more microtextured (or microstructured) or nanotextured (or nanostructured) anti-reflection coatings configured to reduce the reflectivity of the scattering surface 152, thereby enhancing the absorption of the laser beam 50 by the scattering member 150. Also in some embodiments, the scattering surface 152 may have one or more surface relief features configured to tailor the scattering, absorption, or thermal conductivity properties for particular applications. In various embodiments, the surface relief features or nanotextured surface features may be formed by irradiating the scattering surface 152 with one or more laser beams having sufficient intensity to modify the scattering surface 152 in order to enhance the scattering, reflection, or absorption of the laser beam 50 by the scattering member 150.

In many of the embodiments described above, the scattering member 150 may be opaque or at least mostly opaque to the laser beam 50. In other embodiments, the scattering member 150 may be partially transmissive to the laser beam 50, thereby reflecting at least a portion of the laser beam 50, absorbing at least a portion of the laser beam 50, and allowing at least a portion of the laser beam 50 to propagate therethrough, to be partially scattered, partially absorbed, and/or for a portion of the of the laser beam 50 to propagate through a portion of the scattering surface 152 opposite from the incident point 154 from which the surface that the laser beam 50 entered, to be absorbed by the heat sink 130.

When provided as described above, the scattering member 150 is configured to reflect, scatter, absorb or any combination thereof, the incident laser beam 50. The incident laser beam 50 may be pulsed, quasi-continuous-wave (QCW), or continuous-wave (CW), having any of a wide variety of pulse widths (e.g., microsecond, nanosecond, picosecond, femtosecond), wavelengths, (e.g., in the ultraviolet, visible, or infrared ranges), or pulse repetition rates (e.g., kHz, MHz, etc.).

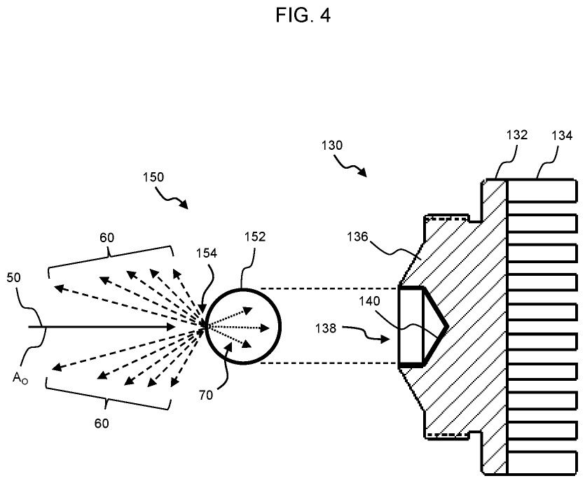

FIG. 4 shows an exploded cross-section view of the scattering member 150 and the heat sink 130 of the embodiment of the beam dump assembly 100 shown in FIG. 3, exploded to show additional details regarding the interface between the laser beam 50 and the scattering member 150 and the interface between the scattering member 150 and the heat sink 130. As described above, in the illustrated embodiment, the incident laser beam 50 is incident at the incident point 154 on the scattering surface 152. Due to the curvilinear shape of the scattering surface 152, portions of the laser beam 50 are scattered or reflected in multiple directions as scattered radiation 60, shown by the dashed arrows. The scattered radiation 60 is then incident on the interior surface 116 of the housing body 112 (shown in FIG. 3). The heat sink 130 has the heat sink body 132 has the thermally conductive features 134, the protrusion 136, and the recess 138 formed thereon, as described above with respect to FIG. 3. In this embodiment, the recess 138 has a hollow cylindrical shape with angled surfaces as if the recess 138 was formed using a standard twist drill. In this embodiment, the fastening feature 140 is a layer of epoxy applied to the surfaces of the recess 138 sufficiently thick so that when the scattering member 150 in placed in the recess 138, the epoxy is in full contact with the surfaces of the recess 138 and the scattering surface 152 in order to effectively transfer thermal energy from the scattering member 150 to the heat sink body 132. In other embodiments, the recess 138 may have a concave hemispherical shape having the same radius as the scattering member 150 that will also effectively transfer thermal energy from the scattering member 150 to the heat sink body 132.

Depending on the material of the scattering member 150, a portion of the laser beam 50 may propagate through the scattering surface 152 into the interior of the scattering member 150 as transmitted radiation 70 (e.g., if the material is translucent). The transmitted radiation 70 then may be further scattered and absorbed within the volume of the scattering member 150, creatin

g additional thermal energy within the scattering member 150. In other embodiments, thermal energy present in the scattering member 150 may radiate away from the scattering surface 152 into the interior volume 118 within the housing body 112, to be absorbed by the housing body 112 and transferred into the ambient environment. In other embodiments, the laser beam 50 may be incident on the scattering surface 152 at multiple incident points.

The foregoing is illustrative of embodiments and examples of the invention, and is not to be construed as limiting thereof. Although a few specific embodiments and examples have been described with reference to the drawings, those skilled in the art will readily appreciate that many modifications to the disclosed embodiments and examples, as well as other embodiments, are possible without materially departing from the novel teachings and advantages of the invention. Accordingly, all such modifications to the subject matter described herein are intended to be included within the scope of the invention as defined in the claims. For example, skilled persons will appreciate that the subject matter of any sentence, paragraph, example or embodiment can be combined with subject matter of some or all of the other sentences, paragraphs, examples or embodiments, except where such combinations are mutually exclusive. The scope of the present invention should, therefore, be determined by the following claims, with equivalents of the claims to be included therein.

What is claimed is:

1. A laser beam dump assembly, comprising:
at least one beam dump housing having at least one housing body having at least one passage formed therein, wherein the at least one passage is sized to allow at least one incident laser beam to propagate therethrough into at least one interior volume formed in the at least one housing body;
at least one beam scattering member having at least one curvilinear scattering surface configured to scatter or reflect at least a first portion of the at least one incident laser beam and allow a second portion of the incident laser beam to be absorbed by the at least one beam scattering member as thermal energy; and
at least one heat sink detachably coupled to the at least one beam dump housing and in thermal communication with the at least one beam scattering member, wherein the at least one heat sink is configured to absorb at least a portion of the thermal energy from the at least one beam scattering member,
wherein the at least one curvilinear beam scattering surface has a spherical shape.

2. The laser beam dump assembly of claim 1, wherein the at least one curvilinear beam scattering surface has a hemispherical shape.

3. The laser beam dump assembly of claim 1, wherein the at least one curvilinear beam scattering surface has an elliptical shape.

4. The laser beam dump assembly of claim 1, wherein the at least one curvilinear beam scattering surface has an oval shape.

5. The laser beam dump assembly of claim 1, wherein the at least one curvilinear beam scattering surface has a cylindrical shape.

6. The laser beam dump assembly of claim 1, wherein the at least one curvilinear beam scattering surface has an aspherical shape.

7. The laser beam dump assembly of claim 1, wherein the at least one beam scattering member is formed from a ceramic material.

8. The laser beam dump assembly of claim 1, wherein the at least one beam scattering member is formed from a silicon carbide material.

9. The laser beam dump assembly of claim 1, wherein the at least one beam scattering member is formed from a silicon nitride material.

10. The laser beam dump assembly of claim 1, wherein the at least one beam scattering member is formed from a copper tungsten material.

11. The laser beam dump assembly of claim 1, wherein the at least one beam scattering member is formed from a tungsten carbide material.

12. The laser beam dump assembly of claim 1, wherein the at least one beam scattering member is formed from a material selected from a group consisting of Aluminum Nitride (AlN), Boron Carbide (B₄C), a Silicon Carbide/Boron Carbide ceramic composite (SiC/B₄C), Zirconia (ZrO₂), Zirconia-toughened Alumina (Zr—Al₂O₃), Alumina-toughened Zirconia (Al₂O₃—Zr), and machinable glass ceramic.

13. A laser beam dump assembly, comprising:
at least one beam dump housing having at least one housing body having at least one passage formed therein, wherein the at least one passage is sized to allow at least one incident laser beam to propagate therethrough;
at least one beam scattering member having at least one curvilinear scattering surface configured to scatter or reflect at least a first portion of the at least one incident laser beam and allow a second portion of the at least one incident laser beam to be absorbed by the at least one scattering member as thermal energy; and
at least one heat sink in thermal communication with the at least one beam scattering member.

14. The laser beam dump assembly of claim 13, wherein the at least one curvilinear beam scattering surface has a shape selected from a group consisting of spherical shape, hemispherical shape, elliptical shape, oval shape, cylindrical shape, aspherical shape.

15. The laser beam dump assembly of claim 13, wherein the at least one beam scattering member is formed from a ceramic material.

16. The laser beam dump assembly of claim 13, wherein the at least one beam scattering member is formed from a material selected from a group consisting of ceramic materials, silicon carbide materials, silicon nitride materials, copper tungsten materials, and tungsten carbide materials.

17. The laser beam dump assembly of claim 13, wherein the at least one beam scattering member is formed from a material selected from a group consisting of Aluminum Nitride (AlN), Boron Carbide (B₄C), a Silicon Carbide/Boron Carbide ceramic composite (SiC/B₄C), Zirconia (ZrO₂), Zirconia-toughened Alumina (Zr—Al₂O₃), Alumina-toughened Zirconia (Al₂O₃—Zr), and machinable glass ceramic.

18. A laser beam dump assembly, comprising:
at least one beam dump housing having at least one passage formed therein, wherein the at least one passage is sized to allow at least one incident laser beam to propagate therethrough;
at least one beam scattering member having at least one curvilinear scattering surface configured to scatter or reflect at least a first portion of the incident laser beam; and
at least one heat sink in thermal communication with the at least one beam scattering member.

19. The laser beam dump assembly of claim 18, wherein the at least one curvilinear beam scattering surface has a shape selected from a group consisting of spherical shape, hemispherical shape, elliptical shape, oval shape, cylindrical shape, aspherical shape.

20. The laser beam dump assembly of claim 18 wherein the at least one curvilinear scattering surface configured to allow a second portion of the incident laser beam to be absorbed by the scattering member as thermal energy.

21. The laser beam dump assembly of claim 18, wherein the at least one beam scattering member is formed from a ceramic material.

22. The laser beam dump assembly of claim 18, wherein the at least one beam scattering member is formed from a material selected from a group consisting of ceramic materials, silicon carbide materials, silicon nitride materials, copper tungsten materials, and tungsten carbide materials.

23. The laser beam dump assembly of claim 18, wherein the at least one beam scattering member is formed from a material selected from a group consisting of Aluminum Nitride (AlN), Boron Carbide (B₄C), a Silicon Carbide/Boron Carbide ceramic composite (SiC/B₄C), Zirconia (ZrO₂), Zirconia-toughened Alumina (Zr—Al₂O₃), Alumina-toughened Zirconia (Al₂O₃—Zr), and machinable glass ceramic.
